(19) United States
(12) Patent Application Publication
(10) Pub. No.: US 2026/0369035 A1
(43) Pub. Date: Nov. 19, 2026

(54) COUNTERFACTUAL IMAGES FOR TRAINING MACHINE-LEARNING CLASSIFIER

(71) Applicant: Ford Global Technologies, LLC, Dearborn, MI (US)

(72) Inventors: Jian Hu, Ann Arbor, MI (US); Gengxin Li, Farmington Hills, MI (US); Ming Gao, Troy, MI (US); Amit Ramesh Karjol, Farmington Hills, MI (US); Steven Kraine, Bloomfield Hills, MI (US); Ali Hassani, Ann Arbor, MI (US); Yuming Niu, Northville, MI (US)

(73) Assignee: Ford Global Technologies, LLC, Dearborn, MI (US)

(21) Appl. No.: 19/207,479

(22) Filed: May 14, 2025

(51) Int. Cl. G06V 10/764; G06F 16/55; G06N 20/00; G06T 11/60

(52) U.S. Cl. CPC G06V 10/764; G06F 16/55; G06N 20/00; G06T 11/60

(57) ABSTRACT

A computer includes a processor and a memory, and the memory stores instructions executable by the processor to, based on a query image classified by a machine-learning classifier into a first class and a reference image classified by the machine-learning classifier into a second class, generate a counterfactual image that is on a boundary separating the first class and the second class; and determine a set of dispositive features responsible for the machine-learning classifier classifying the query image into the first class, based on the counterfactual image.

### BACKGROUND

Classification models are machine-learning algorithms for classifying images. As one example, a classification model can be a convolutional neural network (CNN). A CNN is programmed to accept images as input and output a classification. A CNN includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential classification, and the final output is the classification with the highest score. Other types of models also serve as classifiers.

### BRIEF DESCRIPTION OF THE DRAWINGS

FIG. 1 is a block diagram of an example control system.

FIG. 2 is a diagram of an example machine-learning architecture for classifying images.

FIG. 3 is a diagram of an example mapping of classes for the images in probability space.

FIG. 4 is a flowchart of an example process for determining dispositive features for the machine-learning architecture to classify a query image.

FIG. 5 is a block diagram of an example vehicle with the machine-learning architecture installed.

### DETAILED DESCRIPTION

This disclosure provides techniques for explaining the outcomes of a machine-learning classifier, thereby facilitating modification of the machine-learning classifier. In particular, the techniques can find the features of an image that are responsible for classification in one class versus another class. Based on a query image classified by the machine-learning classifier into a first class and a reference image classified by the machine-learning classifier into a second class, the computer generates a counterfactual image that is on a boundary separating the first class and the second class. Based on the counterfactual image, the computer determines a set of dispositive features responsible for the machine-learning classifier classifying the query image into the first class. By using a counterfactual image on the boundary rather than a counterfactual image fully within the second class, the computer is better able to find the dispositive features that are most responsible for the classification. Moreover, the techniques herein are able to find dispositive features beyond what a human subject-matter expert would suspect, and they can explain the classification of the query image into the first class when the subject-matter expert believes the query image should have been classified into the second class. The techniques can thus facilitate enhanced performance by the machine-learning classifier.

A computer includes a processor and a memory, and the memory stores instructions executable by the processor to, based on a query image classified by a machine-learning classifier into a first class and a reference image classified by the machine-learning classifier into a second class, generate a counterfactual image that is on a boundary separating the first class and the second class; and determine a set of dispositive features responsible for the machine-learning classifier classifying the query image into the first class, based on the counterfactual image.

In an example, the instructions may further include instructions to execute a machine-learning backbone, the machine-learning backbone programmed to generate a set of preliminary features from an input image, the machine-learning classifier taking the preliminary features as an input, the set of dispositive features being a subset of the preliminary features. In a further example, the instructions may further include instructions to determine a set of potentially dispositive features based on the counterfactual image, the set of potentially dispositive features being a subset of the set of preliminary features, the set of dispositive features being a subset of the set of potentially dispositive features. In a still further example, the instructions may further include instructions to rank the potentially dispositive features by contributions to the machine-learning classifier classifying the query image into the first class, the set of dispositive features being a set of the potentially dispositive features ranked highest. In a yet still further example, the counterfactual image may be an initial counterfactual image, and the instructions may further include instructions to determine the contributions by each potentially dispositive feature by determining a score as a function of (1) a first distance in feature space between the query image and the initial counterfactual image and (2) a second distance in feature space between the query image and a fixed-feature counterfactual image generated while fixing the potentially dispositive feature. In a continuing example, the fixed-feature counterfactual image may be on the boundary separating the first class and the second class.

In another yet still further example, the instructions may further include instructions to determine the set of dispositive features by generating alternative counterfactual images with modified values for the potentially dispositive features ranked highest.

In another yet still further example, the instructions may further include instructions to determine the set of dispositive features by, iteratively for the respective potentially dispositive features in descending order of ranking by the contribution, generating an alternative counterfactual image with a modified value for the respective potentially dispositive feature. In a continuing example, the instructions to iteratively generate the alternative counterfactual images may include instructions to cease iterating in response to a most recent of the alternative counterfactual images being classified in the second class, and the set of dispositive features may include the potentially dispositive features from the iterations performed.

In another continuing example, each alternative counterfactual image may include the modified values for the potentially dispositive features from previous iterations.

In another still further example, the instructions may further include instructions to determine the set of potentially dispositive features by including each preliminary feature for which a difference between values of the preliminary feature in the query image and the counterfactual image is above a threshold.

In an example, the instructions to generate the counterfactual image may include instructions to determine the counterfactual image that optimizes an objective function, and the objective function may include a maximum difference in probability between the counterfactual image belonging to the second class versus any other class.

In an example, the instructions to generate the counterfactual image may include instructions to determine the counterfactual image that optimizes an objective function, and the objective function may include a distance in feature space between the counterfactual image and the query image.

In an example, the instructions to generate the counterfactual image may include instructions to determine the counterfactual image that optimizes an objective function, and the objective function may include a distance in pixel space between the counterfactual image and the query image.

In an example, the instructions to generate the counterfactual image may include instructions to determine the counterfactual image that optimizes an objective function, and the objective function may penalize features for being outside respective ranges, the ranges being functions of respective differences in respective features between the query image and the reference image.

A method includes, based on a query image classified by a machine-learning classifier into a first class and a reference image classified by the machine-learning classifier into a second class, generating a counterfactual image that is on a boundary separating the first class and the second class; and determining a set of dispositive features responsible for the machine-learning classifier classifying the query image into the first class, based on the counterfactual image.

In an example, the method may further include executing a machine-learning backbone, the machine-learning backbone programmed to generate a set of preliminary features from an input image, the machine-learning classifier taking the preliminary features as an input, the set of dispositive features being a subset of the preliminary features. In a further example, the method may further include determining a set of potentially dispositive features based on the counterfactual image, the set of potentially dispositive features being a subset of the set of preliminary features, the set of dispositive features being a subset of the set of potentially dispositive features. In a still further example, the method may further include ranking the potentially dispositive features by contributions to the machine-learning classifier classifying the query image into the first class, the set of dispositive features being a set of the potentially dispositive features ranked highest.

In another still further example, the method may further include determining the set of potentially dispositive features by including each preliminary feature for which a difference between values of the preliminary feature in the query image and the counterfactual image is above a threshold.

With reference to the Figures, wherein like numerals indicate like parts throughout the several views, a computer 105 includes a processor and a memory, and the memory stores instructions executable by the processor to, based on a query image 305 classified by a machine-learning classifier 205 into a first class 325 and a reference image 310 classified by the machine-learning classifier 205 into a second class 330, generate a counterfactual image 315 that is on a boundary 320 separating the first class 325 and the second class 330; and determine a set of dispositive features responsible for the machine-learning classifier 205 classifying the query image 305 into the first class 325, based on the counterfactual image 315.

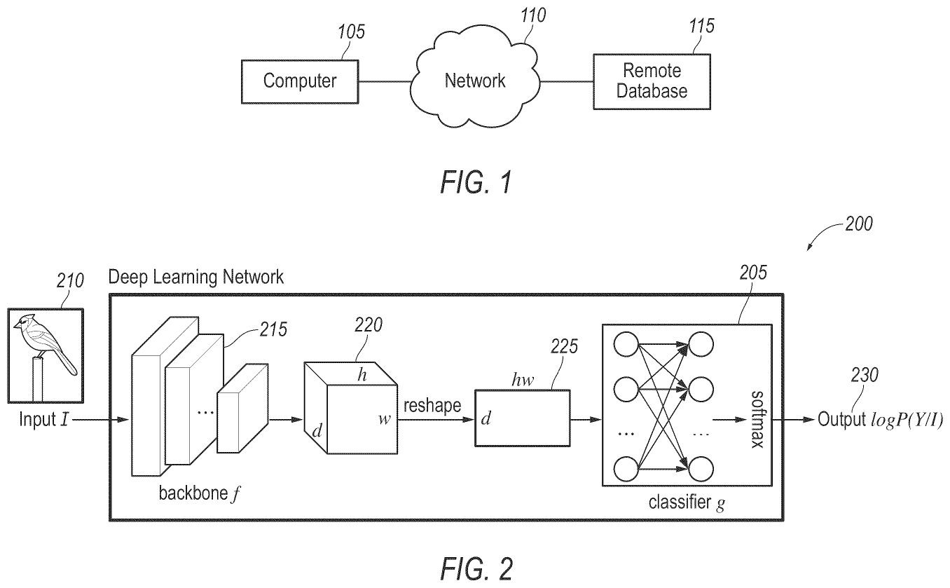

With reference to FIG. 1, the computer 105 is a microprocessor-based computing device such as a generic computing device including a processor and a memory. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may be communicatively coupled to a network 110. The network 110 represents one or more mechanisms by which the computer 105 may communicate with a remote database 115. Accordingly, the network 110 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, IEEE 802.11, etc.), local area networks (LAN) and/or wide area networks (WAN), including the Internet, providing data communication services.

The remote database 115 may be memory remotely accessible by the computer 105 via the network 110. The remote database 115 may be multiple databases. The remote database 115 may be at least partly publicly accessible. The remote database 115 may store collections of images useful for training machine-learning models, such as the machine-learning classifier 205. The images described below may be accessed from the remote database 115.

With reference to FIG. 2, the computer 105 may store a machine-learning architecture 200 and may be programmed to execute the machine-learning architecture 200. As a general overview, the machine-learning architecture 200 includes a machine-learning backbone 215 and the machine-learning classifier 205. The machine-learning backbone 215 receives an input image 210 (e.g., the query image 305 or the reference image 310) as input, and the machine-learning backbone 215 outputs a feature map 220. The computer 105 may reshape the feature map 220 into a reshaped feature map 225. The machine-learning classifier 205 receives the reshaped feature map 225 as input, and the machine-learning classifier 205 outputs a probability distribution 230 for classifying the input image 210 into a set of classes.

Each input image 210 is a two-dimensional matrix of pixels. Each pixel has a brightness or color represented as one or more numerical values, such as a scalar unitless value of photometric light intensity between 0 (black) and 1 (white), or values for each of red, green, and blue (e.g., each on an 8-bit scale (0 to 255) or a 12- or 16-bit scale). The pixels may be a mix of representations (e.g., a repeating pattern of scalar values of intensity for three pixels and a fourth pixel with three numerical color values, or some other pattern). Position in the input image 210 (i.e., position in the field of view of the camera at the time that the input image 210 frame was recorded) can be specified in pixel dimensions or coordinates (e.g., an ordered pair of pixel distances), such as a number of pixels from a top edge and a number of pixels from a left edge of the input image 210.

The features generated by the machine-learning backbone 215 are referred to as “preliminary features” herein, to differentiate from the potentially dispositive features and dispositive features discussed below. For the purposes of this disclosure, the term “feature” is used in its computer-vision sense as a piece of information about the content of an image, specifically about whether a certain region of the image has certain properties. Types of features may include edges, corners, blobs, etc.

The computer 105 is programmed to generate the feature map 220 from the input image 210. Generating the feature map 220 includes executing the machine-learning backbone 215. The machine-learning backbone 215 may include one or more suitable techniques for feature extraction, such as basic techniques such as edge detection, corner detection, blob detection, ridge detection, scale-invariant feature transform (SIFT), etc.; shape-based techniques such as thresholding, blob extraction, template matching, Hough transform, generalized Hough transform, etc.; flexible methods such as deformable parameterized shapes, active contours, etc.; etc. The machine-learning backbone 215 may include machine-learning operations. For example, the machine-learning backbone 215 may include residual network (ResNet) layers followed by a convolutional neural network. The machine-learning backbone 215 generates the set of preliminary features in the form of the feature map 220.

The feature map 220 includes the preliminary features. The feature map 220 provides locations in the input image 210 (e.g., in pixel coordinates) of the preliminary features. The feature map 220 has a reduced dimensionality compared to the input image 210. The feature map 220 may have dimensions h×w×d, in which h is the height, w is the width, and d is the number of channels. Each location (h, w) in the feature map 220 may be one of the preliminary features, described by the values of the channels d at the location (h, w).

The computer 105 may be programmed to reshape the feature map 220 into the reshaped feature map 225, in order to provide the preliminary features in a proper format for the machine-learning classifier 205. For example, the feature map 220 may be reshaped into a two-dimensional matrix, with each location (h, w) as an entry along a row of the matrix. The reshaped feature map 225 thus has dimensions (hw)×d.

The machine-learning classifier 205 takes the preliminary features as an input (e.g., in the form of the feature map 220 or reshaped feature map 225) and outputs the probability distribution 230 indicating a class into which the input image 210 is classified. The machine-learning classifier 205 may be any suitable algorithm for outputting a classification of a feature map, such as a fully connected network.

The probability distribution 230 indicates probabilities that the image should be classified as each of a plurality of predefined classes, as in the following expression: log P(Y=k|I)=gₖ(f(I)), in which P indicates a probability function, Y is a random variable representing the class, k is an index of the class, I is the input image 210, gₖ is the output of the machine-learning classifier 205 for the class k, and f is the output of the machine-learning backbone 215. The outputted class is the class k having the highest probability. The machine-learning classifier 205 may include a softmax function as the final layer in order to output the probability distribution 230.

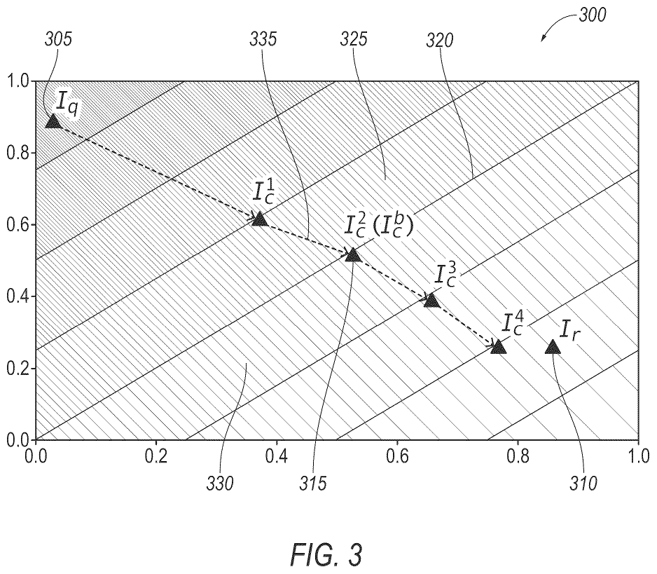

With reference to FIG. 3, the computer 105 is programmed to determine a set of dispositive features responsible for the machine-learning classifier 205 classifying the query image 305 into the first class 325, based on one or more counterfactual images generated to be on a boundary 320 separating the first class 325 and the second class 330. FIG. 3 is a plot of the locations of the query image 305, the reference image 310, and an initial counterfactual image 315 in a probability space 300. The vertical axis may be the probability of an input image 210 being in the first class 325 as returned in the probability distribution 230 from the machine-learning architecture 200, and the horizontal axis may be the probability of the input image 210 being in the second class 330 as returned in the probability distribution 230 from the machine-learning architecture 200. The progression 335 of images shows the effects of optimizing the objective function described below in modifying the query image 305 to become more similar to the reference image 310.

As a general overview, the computer 105 receives the query image 305 and the reference image 310. The computer 105 generates an initial counterfactual image 315 that is on the boundary 320 separating the first class 325 and the second class 330. The computer 105 determines a set of potentially dispositive features based on the initial counterfactual image 315. The set of potentially dispositive features is a subset of the preliminary features. For each potentially dispositive feature, the computer 105 generates a fixed-feature counterfactual image by fixing the potentially dispositive feature, and determines a contribution by the potentially dispositive feature based on the fixed-feature counterfactual image. The computer 105 then ranks the potentially dispositive features by their contributions. Starting with the query image 305, the computer 105 iteratively modifies the values of the potentially dispositive features to generate a series of alternative counterfactual images, in order of the ranking by contribution starting with the highest contribution, until the alternative counterfactual image changes classification. The potentially dispositive features with changed values become a set of dispositive features. The set of dispositive features is thus a subset of the set of potentially dispositive features (namely, the potentially dispositive features ranked highest).

The query image 305 and the reference image 310 are chosen to test why the machine-learning classifier 205 placed the query image 305 into the first class 325. The query image 305 is classified by the machine-learning classifier 205 into the first class 325, and the reference image 310 is classified by the machine-learning classifier 205 into the second class 330. The query image 305 may be chosen because a subject-matter expert believes that it is surprising, unusual, or interesting that the machine-learning classifier 205 placed the query image 305 into the first class 325 rather than the second class 330. The reference image 310 may be chosen to be similar to the query image 305 but instead placed in the second class 330 by the machine-learning classifier 205. The reference image 310 can serve as a baseline for testing differences with the query image 305 (as described in detail below with respect to a third component of an objective function).

The computer 105 is programmed to, based on the query image 305 and the reference image 310, generate the initial counterfactual image 315 that is on the boundary 320 separating the first class 325 and the second class 330. As a general overview, the computer 105 determines the initial counterfactual image 315 that optimizes an objective function. The choice of the objective function and optimization techniques can push the initial counterfactual image 315 to the boundary 320 between the first class 325 and the second class 330.

The computer 105 is programmed to determine the initial counterfactual image 315 that optimizes the objective function. The objective function may be a weighted sum of multiple components, as given in the following expression:

[symbol]

=λ₁F₁(I)+λ₂F₂(I)+λ₃F₃(I)

in which, λ₁, λ₂, λ₃ are weights, F₁, F₂, F₃ are component functions, and I is the stand-in variable for the initial counterfactual image 315 while being generated. The component functions may be chosen to guide the development of the initial counterfactual image 315. For example, the first component function F₁ may be chosen to push the query image 305 toward the second class 330, the second component function F₂ may be chosen to minimize the difference between the initial counterfactual image 315 and the query image 305, and the third component function F₃ may be chosen to restrict preliminary features that are similar between the query image 305 and reference image 310 from changing (thereby focusing changes on preliminary features that a subject-matter expert did not consider important when selecting the reference image 310). The weights λ₁, λ₂, λ₃ may be chosen to according to an importance of the component functions in guiding the development of the initial counterfactual image 315. The third weight λ₃ may be chosen to be sufficiently larger than the first and second weights λ₁ and λ₂ to focus changes on the preliminary features considered less important or explanatory by the subject-matter expert.

The objective function (e.g., the first component function) may include a maximum difference in probability between the counterfactual image belonging to the second class 330 versus any other class, such as given by the following expression:

$${F}_{1} ( I ) = {max}_{i \neq {k}^{′}} ( {g}_{i} ( f ( I ) ) - {g}_{{k}^{′}} ( f ( I ) ) )$$

in which i is an index of the classes and k′ is the index value of the second class 330. In other words, the first component function checks the probabilities of the image being in all the classes other than the second class 330, then selects the probability that is the greatest, and returns the difference between the selected probability and the probability that the image is in the second class 330. When the first component function F₁ is zero, the image is on the boundary 320 between classes. Because of the other components of the objective function, the image is on the boundary 320 between the second class 330 and the first class 325.

The objective function (e.g., the second component function) may include at least one of a distance in feature space between the initial counterfactual image 315 and the query image 305 or a distance in pixel space between the initial counterfactual image 315 and the query image 305. The distance in feature space is a distance between matrices representing the features for the initial counterfactual image 315 and the query image 305. This distance can control the difference in the preliminary features between the initial counterfactual image 315 and the query image 305. The distance in pixel space is a distance between matrices representing the images for the initial counterfactual image 315 and the query image 305. This distance can push the initial counterfactual image 315 toward looking similar to the query image 305, thereby enhancing the interpretability of the initial counterfactual image 315. The type of distance may be an L1 norm, an L2 norm, or some combination. For example, the second component function may be a weighted sum of the squares of the L1 norm between the preliminary features of the initial counterfactual image 315 and the query image 305, the L2 norm between the preliminary features of the initial counterfactual image 315 and the query image 305, and the L1 norm between the initial counterfactual image 315 and the query image 305, as given by the following expression:

$${F}_{2} ( I ) = α {‖ f ( I ) - f ( {I}_{q} ) ‖}_{1}^{2} + β {‖ f ( I ) - f ( {I}_{q} ) ‖}_{2}^{2} + γ {‖ I - {I}_{q} ‖}_{1}^{2}$$

in which α, β, γ are weights of the distances, I_{q} is the query image 305,∥∥₁ is the L1 norm, and ∥∥₂ is the L2 norm. The weights α, β, γ may be chosen to keep the different distances comparable. The use of both the L1 norm and the L2 norm can help to limit both the number of preliminary features being different as well as the magnitudes of the differences of the preliminary features.

The objective function (e.g., the third component function) may penalize the preliminary features for being outside respective ranges. For example, the third component function may be a distance (e.g., the L2 norm) of the values of the preliminary features that exceed corresponding upper range values plus the values of the preliminary features that fall below corresponding lower range values, as given in the following expression:

$${F}_{3} ( I ) = {‖ {( l ( {I}_{q} , {I}_{r} ) - f ( I ) )}_{+} + {( f ( I ) - u ( {I}_{q} , {I}_{r} ) )}_{+} ‖}_{2}^{2}$$

in which l is a vector-valued function of the lower range values, Iᵣ is the reference image 310, u is a vector-valued function of the upper range values, and (x)₊=max {x, 0} returns element-wise maximum of the vector or matrix x and zero. The lower and upper ranges may be functions of respective differences in respective features between the query image 305 and the reference image 310. For each preliminary feature, the difference may be the absolute value of the difference between the value of the preliminary feature in the query image 305 and the value of the preliminary feature in the reference image 310, as given in the following expression:

hⱼ(I_{q},Iᵣ)=|fⱼ(I_{q})−fⱼ(lᵣ)I

in which j is an index of the preliminary features and fⱼ is the value of the jth preliminary feature. The lower range value for each preliminary feature may be the minimum value of the preliminary feature among the query image 305 and reference image 310, decreased by a factor of the difference hⱼ, as given in the following expression:

lⱼ(I_{q},Iᵣ)=min{fⱼ(I_{q}),fⱼ(lᵣ)}−δhⱼ(I_{q},Iᵣ)

in which δ is the factor. The upper range value for each preliminary feature may be the maximum value of the preliminary feature among the query image 305 and reference image 310, increased by the factor of the difference hⱼ, as given in the following expression:

uⱼ(I_{q},Iᵣ)=max{fⱼ(I_{q}),fⱼ(Iᵣ)}+δhⱼ(I_{q},Iᵣ)

As a result, if a preliminary feature j has similar values in the reference image 310 and the query image 305, then the upper and lower values uⱼ and lⱼ will be close together, restricting how much the preliminary feature j can change when generating the initial counterfactual image 315. If the preliminary feature j has disparate values in the reference image 310 and the query image 305, then the upper and lower values uⱼ and lⱼ will be farther apart, permitting greater change in the preliminary feature j when generating the initial counterfactual image 315.

The computer 105 may execute any suitable optimization algorithm for optimizing the objective function while enforcing the condition that the initial counterfactual image 315 is on the boundary 320 between the first class 325 and the second class 330. For example, the computer 105 may use the bisection method. The computer 105 may hold the weights λ₂ and λ₃ for the second and third component functions F₂ and F₃ constant, while iteratively adjusting the weight i for the first component function F₁ along with the initial counterfactual image 315 I. The beginning state of the initial counterfactual image 315 I may be set to the query image 305. The computer 105 may thereby enforce that F₁=0, meaning that the initial counterfactual image 315 is on the boundary 320.

The computer 105 is programmed to determine the set of potentially dispositive features based on the initial counterfactual image 315. The set of potentially dispositive features is a subset of the set of preliminary features; in other words, some but not necessarily all of the preliminary features are potentially dispositive features. The computer 105 may determine the set of potentially dispositive features by including each preliminary feature for which the absolute value of the difference between values of the preliminary feature in the query image 305 and the counterfactual image is above a threshold, as given by the following expression:

S={j|fⱼ(I_{q})−fⱼ(I_{c})|>θ}

in which S is the set of potentially dispositive features, I_{c} is the initial counterfactual image 315 after being generated, and θ is the threshold. The threshold θ may be chosen to indicate whether a preliminary feature has a noticeable or strong effect.

The computer 105 may be programmed to generate a plurality of fixed-feature counterfactual images. The computer 105 generates each fixed-feature counterfactual image by following the same steps described above for generating the initial counterfactual image 315, while fixing the value of one of the potentially dispositive features (referred to as the potentially dispositive feature of interest). Accordingly, the fixed-feature counterfactual image is on the boundary 320 separating the first class 325 and the second class 330. In order to fix the value of one of the potentially dispositive features, the computer 105 performs the steps above using a modified version of the third component function, in which the upper and lower values of the range are set equal to the current value of the potentially dispositive feature of interest. In other words, the range for the potentially dispositive feature of interest is instead a point value at the current value. The modified third component function may be given by the following expressions:

$${\hat{F}}_{3} ( I \vert - i ) = {‖ {( {\hat{l}}^{i} ( {I}_{q} , {I}_{r} ) - f ( I ) )}_{+} + {( f ( I ) - {\hat{u}}^{i} ( {I}_{q} , {I}_{r} ) )}_{+} ‖}_{2}^{2}$$

in which the jth elements of the vectors \hat{l}ⁱ(I_{q}, Iᵣ) and ûⁱ(I_{q}, Iᵣ) may be given as

$${\hat{l}}_{j}^{i} ( {I}_{q} , {I}_{r} ) = \{ \begin{matrix}{f}_{i} ( {I}_{q} ) & j = i \\ {l}_{j} ( {I}_{q} , {I}_{r} ) & j \neq i\end{matrix}$$

$${\hat{u}}_{j}^{i} ( {I}_{q} , {I}_{r} ) = \{ \begin{matrix}{f}_{i} ( {I}_{q} ) & j = i \\ {u}_{j} ( {I}_{q} , {I}_{r} ) & j \neq i\end{matrix}$$

Here, j is an index of the preliminary features and i is the potentially dispositive feature of interest. The computer 105 may generate one fixed-feature counterfactual image for each potentially dispositive feature in the set S.

The computer 105 is programmed to determine the contributions by each potentially dispositive feature. Each contribution may be indicated by a respective score for the potentially dispositive feature. The score may be a function of (1) a first distance in feature space between the query image 305 and the initial counterfactual image 315 and (2) a second distance in feature space between the query image 305 and a fixed-feature counterfactual image generated while fixing the potentially dispositive feature. For example, the function for the score may include a ratio of the first distance and the second distance, as in the following expression:

$$R a n {k}_{i} = 1 - \frac{d ( N )}{d ( N ∖ \{ i \} )}$$

in which d( ) gives the distance in feature space between the query image 305 and a counterfactual image determined by varying the set of features in the argument, N is the set of preliminary features, and M{i} is the set of preliminary features with the ith potentially dispositive feature excluded (i.e., fixed for generating the counterfactual image). The more important the ith feature is, the more the first and second distance will differ. If the first and second distances are approximately equal (i.e., d(N)≈d(N\{i})), then Rankᵢ will be close to zero. If the first distance is significantly smaller than the second distance (i.e., d (N)<<d(N\{i})), then Rankᵢ will be close to 1.

The first distance may be a distance in feature space (e.g., an L2 norm) between the query image 305 and the initial counterfactual image 315, as given by the following expression:

d(N)=∥f(I_{q})−f(I_{c})∥₂

The second distance may be a distance in feature space (e.g., the same type of distance as the first distance) between the query image 305 and the fixed-feature counterfactual image generated while fixing the ith potentially dispositive feature, as given in the following expression:

$$d ( N ∖ \{ i \} ) = {‖ f ( {I}_{q} ) - f ( {I}_{c}^{( - i )} ) ‖}_{2}$$

in which

$${I}_{c}^{( - i )}$$

is the fixed-feature counterfactual image generated while fixing the ith potentially dispositive feature.

The computer 105 may be programmed to rank the potentially dispositive features by contributions to the machine-learning classifier 205 classifying the query image 305 into the first class 325. For example, the computer 105 may rank the potentially dispositive features from the highest score for Rankᵢ to the lowest score for Rankⱼ.

The computer 105 may be programmed to determine the set of dispositive features by generating alternative counterfactual images with modified values for the potentially dispositive features ranked highest. As a general overview, the computer 105 may determine the set of dispositive features by, iteratively for the respective potentially dispositive features in descending order of ranking by the contribution, generating an alternative counterfactual image with a modified value for the respective potentially dispositive feature. The computer 105 may start with the query image 305. At each iteration, the computer 105 adds the next modified value in the ranking, along with the previous modified values. For example, at the third iteration, the computer 105 generates an alternative counterfactual image with modified values for the three highest ranked potentially dispositive features. The iterations may continue until the alternative counterfactual image changes from the first class 325 to the second class 330. The computer 105 may thus be able to identify a minimum set of features responsible for changing the classification of the query image 305.

The computer 105 iteratively adds the respective potentially dispositive features in descending order of ranking by the contribution (i.e., following the order of the ranking performed above). In the first iteration, the computer 105 may modify the value of the highest ranked potentially dispositive features, while keeping the second and lower ranked potentially dispositive features fixed. In the second iteration the computer 105 may modify the values of the highest and second-highest ranked potentially dispositive features, while keeping the third and lower ranked potentially dispositive features fixed. In general, at each iteration, the computer 105 may modify the values of a current potentially dispositive feature and higher ranked potentially dispositive features, while keeping the next and lower ranked potentially dispositive features fixed.

The computer 105 may be programmed to generate the alternative counterfactual images with modified values for the potentially dispositive features ranked highest, for example, a current potentially dispositive feature and any higher ranked potentially dispositive features (i.e., the potentially dispositive features from the previous iterations). The computer 105 generates each alternative counterfactual image by following the same steps described above for generating the initial counterfactual image 315, while fixing the values of the potentially dispositive features ranked lower than the potentially dispositive feature of the current iteration. In order to fix the values of the lower-ranked potentially dispositive features, the computer 105 performs the steps above using a modified version of the third component function, in which the upper and lower values of the range are set equal to the current values of the lower ranked potentially dispositive features, while permitting the values of the potentially dispositive feature of the current iteration and any higher ranked potentially dispositive features to change during the optimization of the objective function. In other words, the ranges for the lower ranked potentially dispositive feature are instead point values at the current values. The modified third component function may be given by the following expressions:

$${\tilde{F}}_{3} ( I ) = {‖ {( \tilde{l} ( {I}_{q} , {I}_{r} ) - f ( I ) )}_{+} + {( f ( I ) - \tilde{u} ( {I}_{q} , {I}_{r} ) )}_{+} ‖}_{2}^{2}$$

in which \tilde{l} and ũ are vector-valued functions with the jth entries given by the following expressions:

$${\tilde{l}}_{( j )} ( {I}_{q} , {I}_{r} ) = \{ \begin{matrix}{f}_{( j )} ( {I}_{q} ) & j > ℓ \\ {l}_{( j )} ( {I}_{q} , {I}_{r} ) & j \leq ℓ\end{matrix}$$

$${\tilde{u}}_{( j )} ( {I}_{q} , {I}_{r} ) = \{ \begin{matrix}{f}_{( j )} ( {I}_{q} ) & j > ℓ \\ {u}_{( j )} ( {I}_{q} , {I}_{r} ) & j \leq ℓ\end{matrix}$$

in which [symbol]
is an index of the current iteration and (j) is an index of the preliminary features sorted [symbol] in descending order of their ranking scores. For example, Rank₍ⱼ₎≥Rank₍ⱼ₊₁₎.

The computer 105 may be programmed to continue iterating as long as a most recent of the alternative counterfactual images is classified in the first class 325 (i.e., the same class as the query image 305) and cease iterating in response to a most recent of the alternative counterfactual images being classified in the second class 330 (i.e., the same class as the reference image 310). The classification changing to the second class 330 may be indicated by the probability of being in the second class 330 outputted by the machine-learning classifier 205 being the maximum among all classes (i.e., the first component function F₁ is zero).

The computer 105 may be programmed to determine the set of dispositive features responsible for the machine-learning classifier 205 classifying the query image 305 into the first class 325 by including the potentially dispositive features from the iterations performed. In other words, the set of dispositive features may (exclusively) include the potentially dispositive features from the iterations performed. For example, if the alternative counterfactual image switched to the second class 330 after four iterations, then the set of dispositive features includes the four highest-ranked potentially dispositive features. The computer 105 may start with an empty set and, after each iteration, add the potentially dispositive feature from that iteration to the set, resulting in the set of dispositive features. The set of dispositive features is a subset of the set of potentially dispositive features (namely, some number of the potentially dispositive features ranked highest); in other words, some but not necessarily all of the potentially dispositive features are dispositive features. The set of potentially dispositive features is a subset of the set of preliminary features, so the set of dispositive features is thereby a subset of the set of preliminary features. Upon determining the set of dispositive features, the computer 105 outputs the dispositive features to an operator. The operator may use the dispositive features to adjust the training of the machine-learning classifier 205 (e.g., so that the machine-learning classifier 205 classifies the query image 305 into the second class 330 rather than the first class 325).

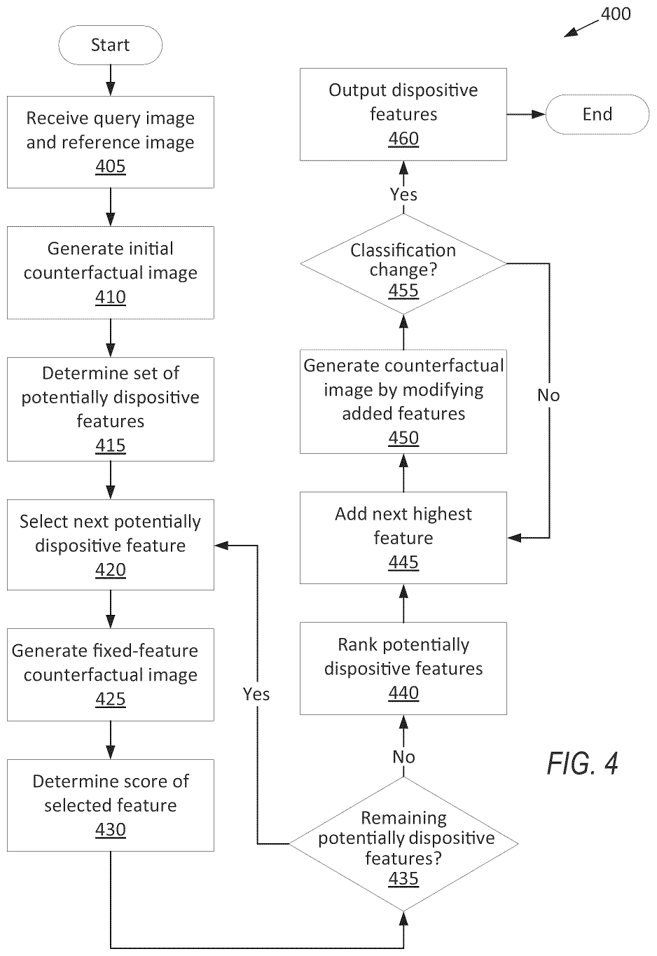

FIG. 4 is a flowchart illustrating an example process 400 for determining the dispositive features for the machine-learning architecture 200 to classify the query image 305. The memory of the computer 105 stores executable instructions for performing the steps of the process 400 and/or programming can be implemented in structures such as mentioned above. As a general overview of the process 400, the computer 105 receives the query image 305 and the reference image 310, generates the initial counterfactual image 315, and determines the set of potentially dispositive features. For each potentially dispositive feature, the computer 105 determines the fixed-feature counterfactual image and determines the contribution by the potentially dispositive feature. The computer 105 ranks the potentially dispositive features. The computer 105, iteratively for the respective potentially dispositive features in descending order of the ranking, generates alternative counterfactual images with modified values for the respective potentially dispositive feature and higher-ranked features, until the alternative counterfactual image changes from the first class 325 to the second class 330. Finally, the computer 105 outputs the dispositive features.

The process 400 begins in a block 405, in which the computer 105 receives the query image 305 and the reference image 310, as described above.

Next, in a block 410, the computer 105 generates the initial counterfactual image 315 based on the query image 305 and the reference image 310 from the block 405, as described above.

Next, in a block 415, the computer 105 determines the set of potentially dispositive features based on the initial counterfactual image 315 from the block 410, as described above.

Next, in a block 420, the computer 105 selects a next one of the potentially dispositive features. For example, the computer 105 may give each potentially dispositive feature an index value and iterate through the index values.

Next, in a block 425, the computer 105 generates a fixed-feature counterfactual image with a value of the selected potentially dispositive feature from the block 420 fixed, based on the query image 305 and the reference image 310 from the block 405, as described above.

Next, in a block 430, the computer 105 determines the contribution of the selected potentially dispositive feature from the block 420 based on the fixed-feature counterfactual image from the block 425 and the query image 305 and the reference image 310 from the block 405, as described above.

Next, in a decision block 435, the computer 105 determines whether any potentially dispositive features remain in the set for which the contributions have not been determined. For example, the computer 105 may determine whether the index of the selected potentially dispositive feature from the block 420 is the last index value for the set of potentially dispositive features. If the index is not at the last index value, the process 400 returns to the block 420 for the next potentially dispositive feature. If the index is at the last index value, the process 400 proceeds to a block 440.

In the block 440, the computer 105 ranks the potentially dispositive features in descending order of their contributions determined in the block 430, as described above.

Next, in a block 445, the selects a next highest ranked potentially dispositive feature according to the ranking from the block 440, starting with the highest-ranked potentially dispositive feature.

Next, in a block 450, the computer 105 generates an alternative counterfactual image with a modified value for the selected potentially dispositive feature from the block 445 and any higher ranked potentially dispositive features, as described above.

Next, in a decision block 455, the computer 105 determines whether the alternative counterfactual image from the block 450 is classified in the second class 330, as described above. In response to the alternative counterfactual image still being in the first class 325, the process 400 returns to the block 445 to add the next potentially dispositive feature. In response to the alternative counterfactual image switching classification to the second class 330, the process 400 ceases iterating and proceeds to a block 460.

In the block 460, the computer 105 determines the set of dispositive features responsible for the machine-learning classifier 205 classifying the query image 305 into the first class 325 by adding the potentially dispositive features selected in the iterations of the block 445, as described above. The computer 105 outputs the set of potentially dispositive features. After the block 460, the process 400 ends.

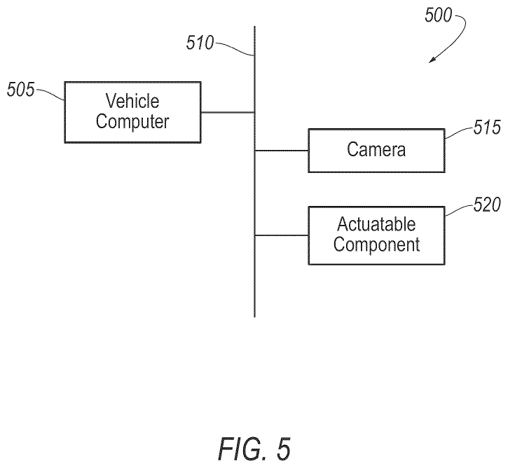

With reference to FIG. 5, the machine-learning architecture 200 (with adjusted training based on the dispositive features) may be deployed onto a vehicle 500. The vehicle 500 may be any passenger or commercial automobile such as a car, a truck, a sport utility vehicle, a crossover, a van, a minivan, a taxi, a bus, etc. The vehicle 500 may include a vehicle computer 505, a communications network 510, a camera 515, and at least one actuatable component 520.

The vehicle computer 505 is a microprocessor-based computing device such as a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). The vehicle computer 505 can thus include a processor, a memory, etc. The memory of the vehicle computer 505 can include media for storing instructions executable by the processor as well as for electronically storing data and/or databases, and/or the vehicle computer 505 can include structures such as the foregoing by which programming is provided. The vehicle computer 505 can be multiple computers coupled together. The machine-learning architecture 200 is installed on the vehicle computer 505.

The vehicle computer 505 may transmit and receive data through the communications network 510. The communications network 510 may be a controller area network (CAN) bus, Ethernet, WiFi, Local Interconnect Network (LIN), onboard diagnostics connector (OBD-II), and/or any other wired or wireless communications network. The vehicle computer 505 may be communicatively coupled to the camera 515, the actuatable component 520, and other components via the communications network 510.

The camera 515 can detect electromagnetic radiation in some range of wavelengths. For example, the camera 515 may detect visible light, infrared radiation, ultraviolet light, or some range of wavelengths including visible, infrared, and/or ultraviolet light. For example, the camera 515 can be a charge-coupled device (CCD), complementary metal oxide semiconductor (CMOS), or any other suitable type.

The actuatable component 520 is a part of the vehicle 500 that are capable of being actuated according to an instruction from the vehicle computer 505 via the communications network 510. In the context of the present disclosure, “actuating” is defined as setting an object into motion or action via a mechanical or electromechanical stimulus. For example, the actuatable component 520 may be part of a propulsion system, a steering system, a suspension system, a climate-control system, etc.

The vehicle computer 505 may be programmed to execute the machine-learning architecture 200 and actuate the actuatable component 520 based on a classification returned by the machine-learning architecture 200. The machine-learning architecture 200 may take as input an image received from the camera 515 via the communications network 510. For example, the vehicle computer 505 may actuate the steering system in response to the machine-learning architecture 200 recognizing a lane line, the vehicle computer 505 may actuate the propulsion system to maintain speed in response to the machine-learning architecture 200 recognizing a stop light lighted green, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

The disclosure has been described in an illustrative manner, and it is to be understood that the terminology which has been used is intended to be in the nature of words of description rather than of limitation. The adjectives “first,” “second,” “third,” etc. are used throughout this document as identifiers and are not intended to signify importance, order, or quantity. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
based on a query image classified by a machine-learning classifier into a first class and a reference image classified by the machine-learning classifier into a second class, generate a counterfactual image that is on a boundary separating the first class and the second class; and
determine a set of dispositive features responsible for the machine-learning classifier classifying the query image into the first class, based on the counterfactual image.

2. The computer of claim 1, wherein the instructions further include instructions to execute a machine-learning backbone, the machine-learning backbone programmed to generate a set of preliminary features from an input image, the machine-learning classifier taking the preliminary features as an input, the set of dispositive features being a subset of the preliminary features.

3. The computer of claim 2, wherein the instructions further include instructions to determine a set of potentially dispositive features based on the counterfactual image, the set of potentially dispositive features being a subset of the set of preliminary features, the set of dispositive features being a subset of the set of potentially dispositive features.

4. The computer of claim 3, wherein the instructions further include instructions to rank the potentially dispositive features by contributions to the machine-learning classifier classifying the query image into the first class, the set of dispositive features being a set of the potentially dispositive features ranked highest.

5. The computer of claim 4, wherein the counterfactual image is an initial counterfactual image, and the instructions further include instructions to determine the contributions by each potentially dispositive feature by determining a score as a function of (1) a first distance in feature space between the query image and the initial counterfactual image and (2) a second distance in feature space between the query image and a fixed-feature counterfactual image generated while fixing the potentially dispositive feature.

6. The computer of claim 5, wherein the fixed-feature counterfactual image is on the boundary separating the first class and the second class.

7. The computer of claim 4, wherein the instructions further include instructions to determine the set of dispositive features by generating alternative counterfactual images with modified values for the potentially dispositive features ranked highest.

8. The computer of claim 4, wherein the instructions further include instructions to determine the set of dispositive features by, iteratively for the respective potentially dispositive features in descending order of ranking by the contribution, generating an alternative counterfactual image with a modified value for the respective potentially dispositive feature.

9. The computer of claim 8, wherein the instructions to iteratively generate the alternative counterfactual images include instructions to cease iterating in response to a most recent of the alternative counterfactual images being classified in the second class, and the set of dispositive features includes the potentially dispositive features from the iterations performed.

10. The computer of claim 8, wherein each alternative counterfactual image includes the modified values for the potentially dispositive features from previous iterations.

11. The computer of claim 3, wherein the instructions further include instructions to determine the set of potentially dispositive features by including each preliminary feature for which a difference between values of the preliminary feature in the query image and the counterfactual image is above a threshold.

12. The computer of claim 1, wherein the instructions to generate the counterfactual image include instructions to determine the counterfactual image that optimizes an objective function, and the objective function includes a maximum difference in probability between the counterfactual image belonging to the second class versus any other class.

13. The computer of claim 1, wherein the instructions to generate the counterfactual image include instructions to determine the counterfactual image that optimizes an objective function, and the objective function includes a distance in feature space between the counterfactual image and the query image.

14. The computer of claim 1, wherein the instructions to generate the counterfactual image include instructions to determine the counterfactual image that optimizes an objective function, and the objective function includes a distance in pixel space between the counterfactual image and the query image.

15. The computer of claim 1, wherein the instructions to generate the counterfactual image include instructions to determine the counterfactual image that optimizes an objective function, and the objective function penalizes features for being outside respective ranges, the ranges being functions of respective differences in respective features between the query image and the reference image.

16. A method comprising:
based on a query image classified by a machine-learning classifier into a first class and a reference image classified by the machine-learning classifier into a second class, generating a counterfactual image that is on a boundary separating the first class and the second class; and
determining a set of dispositive features responsible for the machine-learning classifier classifying the query image into the first class, based on the counterfactual image.

17. The method of claim 16, further comprising executing a machine-learning backbone, the machine-learning backbone programmed to generate a set of preliminary features from an input image, the machine-learning classifier taking the preliminary features as an input, the set of dispositive features being a subset of the preliminary features.

18. The method of claim 17, further comprising determining a set of potentially dispositive features based on the counterfactual image, the set of potentially dispositive features being a subset of the set of preliminary features, the set of dispositive features being a subset of the set of potentially dispositive features.

19. The method of claim 18, further comprising ranking the potentially dispositive features by contributions to the machine-learning classifier classifying the query image into the first class, the set of dispositive features being a set of the potentially dispositive features ranked highest.

20. The method of claim 18, further comprising determining the set of potentially dispositive features by including each preliminary feature for which a difference between values of the preliminary feature in the query image and the counterfactual image is above a threshold.
